(19) United States
(12) Patent Application Publication
(10) Pub. No.: US 2015/0299432 A1
(43) Pub. Date: Oct. 22, 2015

(54) POLYOLEFIN COMPOSITION COMPRISING THERMOPLASTIC STARCH

(71) Applicant: TRISTANO PTY LTD, Balwyn (AU)

(72) Inventors: John SCHEIRS, Moorabbin (AU); Markus LEUFGENS, Frankston (AU)

(21) Appl. No.: 14/423,520

(22) PCT Filed: Aug. 23, 2013
(86) PCT No.: PCT/AU2013/000938

§ 371 Date: Feb. 24, 2015

(30) Foreign Application Priority Data
Aug. 24, 2012 (AU) 2012903672

(51) Int. Cl. C08L 3/02; C08L 23/06

(52) U.S. Cl. CPC C08L 3/02; C08L 23/06; C08L 2205/08; C08L 2207/066; C08L 2201/08; C08L 2205/025; C08L 2205/035; C08L 2310/00

(57) ABSTRACT

A polyolefin composition can include polyolefin, amphipathic polymer compatibiliser, iron palmitate, and thermoplastic starch and/or its constituent components.

### FIELD OF THE INVENTION

The present invention relates in general to polyolefin compositions. In particular, the invention relates to polyolefin compositions comprising polyolefin and a pro-degradant, to a method of preparing the same, and to products formed therefrom.

### BACKGROUND OF THE INVENTION

There has been a large increase in the use of polyolefins, such as polyethylene and polypropylene, owing to their relatively low cost, good mechanical properties and long term stability. However, this increase in usage has created a number of challenges associated with disposal of the polymer and flow on environmental concerns.

On one hand, the excellent physical properties and long term stability of polyolefins makes them particularly attractive for use in the manufacture of consumer products. On the other hand, their long term stability becomes problematic when the consumer product ends up as waste in landfill. In particular, polyolefins do not readily degrade in the natural environment and can persist for hundreds of years.

One challenge has therefore been to develop a polyolefin composition that exhibits similar, if not the same, properties to a corresponding conventional polyolefin composition during its consumer lifetime (i.e. its “useful lifetime”), but can more readily degrade when it becomes waste and enters landfill.

In response, so called “controlled degradable” polyolefin compositions have been developed. For example, metal (e.g. nickel, copper, cobalt) salts have been blended with polyolefin to accelerate in a controlled manner its degradation. Thus, polyolefin compositions can be prepared in such a way so degradation of a consumer product derived from it is timed to coincide with the anticipated end of the products useful lifetime. In this way, the consumer product will more readily degrade when in landfill.

Agents, such as the aforementioned metal salts, that accelerate the degradation of polyolefins (relative to the polyolefin absent the agent) are in known in the art as “pro-degradants”.

Use of pro-degradants in polyolefin compositions have been shown to be effective in accelerating degradation.

Those skilled in the art will appreciate that in this context the term “degradation” is intended to mean that a product made from the polyolefin composition undergoes embrittlement followed by fragmentation or comminution due to a reduction in the polyolefin's molecular weight. Such degradation is known in the art as oxo-degradation and it is not to be confused with biodegradation which requires the action of microorganisms.

Accordingly, upon undergoing oxo-degradation the physical properties of the polyolefin are reduced and products made from it become embrittled to a point where they can readily fragment into smaller pieces. The resulting comminuted degraded product advantageously presents a reduced volume and consequently has lower landfill impact. Also, comminution of the product renders the polymer composition more susceptible over time to bioassimilation through biodegradation.

However, the use of conventional pro-degradants can be problematic in that they are toxic in their own right and give rise toxic residue within the degraded polymer. For example, many pro-degradants are based on toxic heavy metal salts.

Furthermore, conventional controlled degradable polyolefin compositions by in large comprise a high proportion of non-renewable petroleum resources (e.g. at least the polyolefin) and consequently present additional sustainability and environmental concerns.

Biodegradable polymers made at least in part from renewable resources are known, but they typically exhibit poor physical properties relative to polyolefins.

An opportunity therefore remains to develop an alternative polyolefin composition that addresses or ameliorates one or more disadvantage or shortcoming associated with conventional polyolefin compositions, or to at least provide a useful alternative polyolefin composition.

### SUMMARY OF THE INVENTION

The present invention therefore provides a polyolefin composition comprising polyolefin, amphipathic polymer compatibiliser, iron palmitate, and thermoplastic starch and/or its constituent components.

Those skilled in the art will appreciate that compositions comprising polyolefin and starch are renowned for having relatively poor physical and/or degradation properties.

It has now been found that the components of the composition in accordance with the invention can be melt mixed to afford a polyolefin composition that demonstrates excellent physical properties, and can also be tailored to degrade in a controlled manner after a desired period of time. Most notably, the melt mixed compositions can retain the advantageous physical properties of polyolefins, incorporate a significant renewable content (e.g. iron palmitate and thermoplastic starch), and present an ability to degrade in a controlled manner.

Compositions in accordance with the invention can therefore not only be prepared such that they degrade in a controlled manner to help minimise landfill impact, but they also have a lower petrochemical derived content. Consumer products manufactured from the compositions can present such advantages and yet still exhibit excellent physical properties during their useful lifetime.

Compositions in accordance with the invention may be provided in the form of a physical blend of the components, a melt mixed blend of the components, or a combination thereof.

For example, the composition may be provided in the form of a melt mixed blend of all the components.

The composition may also be provided in the form of a physical blend of two or more melt mixed blends, each melt mixed blend being made from two or more of the components. For example, the composition may comprise a physical blend of (1) a melt mixed blend of polyolefin and iron palmitate, and (2) a melt mixed blend of polyolefin, amphipathic polymer compatibiliser, and thermoplastic starch. The composition may also comprise a physical blend of (1) a melt mixed blend of polyolefin and iron palmitate, (2) a melt mixed blend of polyolefin, amphipathic polymer compatibiliser, and thermoplastic starch, and (3) polyolefin.

The composition may also be provided in the form of a physical blend of one or more of the components with one or more melt mixed blends made from two or more of the components. For example, the composition may comprise a physical blend of (1) a melt mixed blend of polyolefin and iron palmitate, (2) polyolefin, (3) amphipathic polymer compatibiliser, and (4) thermoplastic starch and/or its constituent components.

Where the composition is not provided in the form of a melt mixed blend of all the components, it will be appreciated that such a composition will generally be prepared so as to ultimately be melt mixed and form a melt mixed blend of all the components therein.

There can be advantages gained in terms of processability and overall compatiblisation of components in the composition when the melt mixed form of the composition is prepared by melt mixing (a) two or more melt mixed blends, each melt mixed blend being made from two or more of the components, or one or more of the components with one or more melt mixed blends made from two or more of the components.

The thermoplastic starch per se may be provided/used in the form of a melt mixed composition, or it can be prepared in situ from its constituent components during melt mixing of the composition. Accordingly, a composition in accordance with the invention may comprise polyolefin, amphipathic polymer compatibiliser, iron palmitate and thermoplastic starch and/or the constituent components of the thermoplastic starch, namely starch and one or more plasticisers. Where the constituent components of the thermoplastic starch are used, upon being melt mixed the starch and the one or more plasticisers in the composition will be converted into thermoplastic starch and the resulting melt mixed composition will comprise thermoplastic starch. In other words, in melt mixed compositions in accordance with the invention it is the intention that any constituent components of thermoplastic starch in a pre-melt mixed composition will be substantially converted into thermoplastic starch during melt mixing.

In the form of a physical blend, those skilled in the art will appreciate that the composition per se may not exhibit controlled degradability in as much as the iron palmitate pro-degradant may not be intimately blended with the other components of the composition.

Certain compositions according to the invention may be described as a degradable polyolefin composition comprising polyolefin, amphipathic polymer compatibiliser, iron palmitate and thermoplastic starch.

By being provided in the form of a “degradable” polyolefin composition it is intended that the components of the composition (i.e. polyolefin, amphipathic polymer compatibiliser, iron palmitate, and thermoplastic starch and/or its constituent components) are provided in the form of a melt mixed blend.

The present invention may therefore also be described as providing a degradable polyolefin composition comprising, as an integral intimate blend, polyolefin, amphipathic polymer compatibiliser, iron palmitate and thermoplastic starch.

The present invention may also be described as providing a degradable polyolefin composition comprising a melt mixed blend of polyolefin, amphipathic polymer compatibiliser, iron palmitate and thermoplastic starch.

To assist with tailoring a point in time after manufacture at which a composition in accordance with the invention begins to catastrophically degrade, it may be desirable to include in the composition an oxidation inhibiting agent. Such oxidation inhibiting agents are commonly referred to in the art as “stabilisers” and include phenolic antioxidants, radical scavenging compounds, organic phosphites and ultra violet (UV) absorbing compounds.

In one embodiment, the composition in accordance with the invention further comprises an oxidation inhibiting agent.

The efficiency and effectiveness of iron palmitate as a pro-degradant in compositions of the invention can advantageously be enhanced through control of its particle size.

In one embodiment, the average particle size of the iron palmitate is less than one micron, for example within the range of about 80 nm to about 800 nm, or within the range of about 80 nm to about 600 nm.

The present invention also provides a method of preparing a polyolefin composition, the method comprising melt mixing one or more compositions comprising polyolefin, amphipathic polymer compatibiliser, iron palmitate and thermoplastic starch and/or its constituent components.

In one embodiment, the method comprises melt mixing a composition comprising polyolefin and iron palmitate with a composition comprising polyolefin, amphipathic polymer compatibiliser, thermoplastic starch and/or its constituent components.

In another embodiment, the method comprises melt mixing (1) a melt mixed composition comprising polyolefin and iron palmitate, with (2) a melt mixed composition comprising polyolefin, amphipathic polymer compatibiliser, and thermoplastic starch.

In a further embodiment, the method comprises melt mixing (1) a melt mixed composition comprising polyolefin and iron palmitate, with (2) a melt mixed composition comprising polyolefin, amphipathic polymer compatibiliser, and thermoplastic starch, and (3) polyolefin.

To assist with describing the invention, it will be convenient to refer to a melt mixed blend comprising polyolefin, amphipathic polymer compatibiliser, iron palmitate and thermoplastic starch as a “degradable polyolefin composition”.

Where a melt mixed blend comprises two or more of polyolefin, amphipathic polymer compatibiliser, iron palmitate and thermoplastic starch, but not all of these components, it will be convenient to refer to it as a “masterbatch”. For example, a melt mixed blend of polyolefin and iron palmitate, or a melt mixed blend of polyolefin, amphipathic polymer compatibiliser, and thermoplastic starch, may each be referred to as a masterbatch.

As will be discussed in more detail below, such masterbatches can be melt mixed together with one or more other components to form a degradable polyolefin composition according to the invention.

Without wishing to be limited by theory, the excellent physical properties of products formed from compositions in accordance with the invention are believed to stem at least in part from the ability of the compositions to provide for a well dispersed and highly compatibilised mixture of the respective components. This in turn is also believed to provide excellent control in tailoring the time at which consumer products formed from the compositions will begin to catastrophically degrade. In some embodiments of the invention, the thermoplastic starch and polyolefin components of the composition are believed to form a stable co-continuous phase morphology.

The present invention further provides a consumer product comprising a composition in accordance with the invention.

In one embodiment, the consumer product is in the form of a film, a sheet, or molded article.

Compositions in accordance with the invention are particularly suitable for use in the manufacture of agricultural film.

Accordingly, the present invention further provides an agricultural film comprising a composition in accordance with the invention.

Further aspects of the invention are described in more detail below.

### DETAILED DESCRIPTION OF THE INVENTION

Reference herein to a “physical blend” of components is intended to mean that the components present as a mere add-mixture that have not been melt mixed together. For avoidance of any doubt, it will be appreciated that a “physical blend” is in intended to embrace an add-mixture where the components are themselves a melt mixed blend. For example, physical blend may be a mixture of two or more separate melt mixed blends.

Reference herein to a “melt mixed blend” of components is intended to mean that the components have been melt mixed together and present as an integral intimate mass.

As used herein the expression “melt mixed”, “melt mixing” or grammatical variants thereof is intended to mean that at least one thermoplastic component (e.g. a thermoplastic polymer) is heated to a temperature where it can readily flow and be intimately mixed with one or more other components so as to form an integral intimate mass of the combined components.

Unless otherwise stated, all wt. % values referred to herein are wt. % values relative to the total combined mass of components in the composition. The total combined mass of components in a composition will represent 100 wt. %.

As used herein, the expression “co-continuous phase morphology” in the context of thermoplastic starch (TPS) and polyolefin phase domains in intended to mean the topological condition in which a continuous path through either phase domain may be drawn to all phase domain boundaries without crossing any phase domain boundary. By the co-continuous phase morphology being “stable” is meant that the respective phase domains resist coalescence during and after melt processing.

A composition in accordance with the invention comprises polyolefin. As used herein, the term “polyolefin” is intended to mean a homopolymer or copolymer of ethylene, propylene, butenes and other unsaturated aliphatic hydrocarbons, vinyl esters (e.g. vinyl acetate), or (meth)acrylics (e.g. butyl acrylate, acrylic acid). Generally, the polyolefin will be a polymer of ethylene, propylene or copolymer thereof, or a copolymer of ethylene or propylene with one or more C₄-C₁₂α-olefin aliphatic comonomers.

The polyolefin may be virgin polymer (i.e. post-reactor but not yet converted into a consumer product) or waste/recycled polymer.

In one embodiment the polyolefin is a polyethylene homopolymer, copolymer or blend containing one or more polyethylene homopolymers and/or copolymers.

The polyethylene may be very low density polyethylene (VLDPE), low density polyethylene (LDPE), linear low density polyethylene (LLDPE), ultra-low density polyethylene (ULDPE), medium density polyethylene (MDPE), or high density polyethylene (HDPE).

Suitable polyethylene copolymers include copolymers of ethylene and one or more C₃-C₁₂α-olefin aliphatic comonomers. The α-olefin content of the copolymer may range from about 0.1% wt/wt to about 10% wt/wt. Specific α-olefin aliphatic comonomers include propylene, 1-butene, 1-pentene, 1-hexene and 1-octene.

In one embodiment, the polyethylene copolymer is a copolymer of ethylene and propylene.

In another embodiment, the polyolefin used is a polypropylene homopolymer, copolymer or blend containing one or more polypropylene homopolymers and/or copolymers.

Suitable polypropylene homopolymers include isotactic polypropylene, atactic polypropylene and syndiotactic polypropylene.

Suitable polypropylene copolymers include copolymers include copolymers of propylene and one or more C₂ and C₄-C₁₂α-olefin aliphatic comonomers. The α-olefin content of the copolymer may range from about 0.1% wt/wt to about 10% wt/wt. Specific α-olefin aliphatic comonomers include ethylene, 1-butene, 1-pentene, 1-hexene and 1-octene.

In one embodiment, the polypropylene copolymer is a copolymer of propylene and ethylene.

As will be discussed in more detail below, the polyolefin used will be of a type that is susceptible to undergoing oxo-degradation.

Polyolefin compositions in accordance with the invention will generally comprise polyolefin in an amount ranging from about 30 wt. % to about 90 wt. %, for example ranging from about 40 wt. % to about 70 wt. %, or ranging from about 50 wt. % to about 80 wt. %, or ranging from about 50 wt. % to about 60 wt. %.

Polyolefin may be present or used in the form of a masterbatch with amphipathic polymer compatibiliser, and thermoplastic starch. In that case, the polyolefin will be used in an amount ranging from about 5 wt. % to about 60 wt. %, for example ranging from about 10 wt. % to about 45 wt. %, or from 10 wt. % to about 30 wt. %.

Polyolefin may be present or used in the form of a masterbatch with iron palmitate. In that case, the polyolefin will be used in an amount ranging from about 75 wt. % to about 99.5 wt. %, for example ranging from about 80 wt. % to about 98 wt. %, or from 85 wt. % to about 95 wt. %.

In one embodiment, the polyolefin used comprises VLDPE having a density of less than 0.905 g/cm³. Generally, the VLDPE will have a density ranging from about 0.85 g/cm³ to 0.905 g/cm³, for example from about 0.88 g/cm³ to 0.905 g/cm³. VLDPE is also known in the art as ultra low density polyethylene (ULDPE), and is generally a copolymer of ethylene and one or more alpha-olefins such as 1-butene, 1-hexene, and 1-octene.

The VLDPE will generally have a melt index at 190° C./2.16 kg of about 0.5 g/10 min to about 10 g/10 min.

Suitable VLDPE that may be used in accordance with the invention includes, but is not limited to, a ethylene/octene copolymer having a density of about 0.904 g/cm³ and a melt index at 190° C./2.16 kg of about 4 g/10 min, and ethylene/butene copolymer having a density of about 0.884 g/cm³ and a melt index at 190° C./2.16 kg of about 0.7 g/10 min, and an ethylene/butene copolymer having a density of about 0.8985 and melt index at 190° C./2.16 kg of about 5 g/10 min.

Compositions in accordance with the invention may also further comprise one or more polyethylene polymers having a density greater than 0.905 g/cm³. For example, the composition may comprise low density polyethylene (LDPE) which is generally characterised as having a density in the range of 0.910 to 0.940 g/cm³. Suitable grades of LDPE include, but are not limited to, those having a melt index at 190° C./2.16 kg of about 0.2 g/10 min to about 7 g/10 min.

In addition to or separate from LDPE, compositions may comprise linear low density polyethylene (LLDPE) which is generally characterised as having a density ranging from 0.915 g/cm³ to 0.925 g/cm³, medium density polyethylene (MDPE) which is generally characterised as having a density ranging from 0.926 g/cm³ to 0.940 g/cm³, and/or high density polyethylene (HDPE) which is generally characterised as having a density of greater or equal to 0.941 g/cm³.

Suitable grades of VLDPE, LDPE, LLDPE, MDPE and HDPE for use in accordance with the invention may be obtained commercially.

Reference herein to a density or melt index of a polyethylene polymer is intended to mean a density or melt index determined in accordance with ASTM D792 and ASTM D1238, respectively.

The compositions in accordance with the invention further comprise TPS and/or the constituent components thereof. Those skilled in the art will appreciate that TPS is a destructured form of starch comprising one or more plasticisers. Accordingly, as used herein, the expressions “its constituent components” or “constituent components thereof” in the context of TPS is intended to mean the individual ingredients that are used to prepare the TPS.

Starch is found chiefly in seeds, fruits, tubers, roots and stem pith of plants, and is a naturally derived polymer made up of repeating glucose groups linked by glucosidic linkages in the 1-4 carbon positions. Starch consists of two types of alpha-D-glucose polymers: amylose, a substantially linear polymer with molecular weight of about 1×10⁵; and amylopectin, a highly branched polymer with very high molecular weight of the order 1×10⁷. Each repeating glucose unit typically has three free hydroxyl groups, thereby providing the polymer with hydrophilic properties and reactive functional groups. Most starches contain 20 to 30% amylose and 70 to 80% amylopectin. However, depending on the origin of the starch the ratio of amylose to amylopectin can vary significantly. For example, some corn hybrids provide starch with 100% amylopectin (waxy corn starch), or progressively higher amylose content ranging from 50 to 95%. Starch usually has a water content of about 15 wt. %. However, the starch can be dried to reduce its water content to below 1%.

Starch typically exists in small granules having a crystallinity ranging from about 15 to 45%. The size of the granules may vary depending upon the origin of the starch. For example, corn starch typically has a particle size diameter ranging from about 5 μm to about 40 μm, whereas potato starch typically has a particle size diameter ranging from about 50 μm to about 100 μm.

This “native” form of starch may also be chemically modified. Chemically modified starch includes, but is not limited to, oxidised starch, etherificated starch, esterified starch, cross-linked starch or a combination of such chemical modifications (e.g. etherificated and esterified starch). Chemically modified starch is generally prepared by reacting the hydroxyl groups of starch with one or more reagents. The degree of reaction, often referred to as the degree of substitution (DS), can significantly alter the physiochemical properties of the modified starch compared with the corresponding native starch. The DS for a native starch is designated as 0 and can range up to 3 for a fully substituted modified starch. Depending upon the type of substituent and the DS, a chemically modified starch can exhibit considerably different hydrophilic/hydrophobic character relative to native starch.

Both native and chemically modified starch generally exhibit poor thermoplastic properties. To improve such properties, the starch may be converted to TPS by means well known in the art. For example, native or chemically modified starch may be melt processed with one or more plasticisers. Polyhydric alcohols are generally used as plasticisers in the manufacture of TPS.

Reference herein to the wt. % of TPS is therefore intended to include the collective mass of both the starch and plasticiser constituent components of the TPS.

The starch from which the TPS may be derived includes, but is not limited to, corn starch, potato starch, wheat starch, soy bean starch, tapioca starch, hi-amylose starch or combinations thereof.

Where the starch is chemically modified, it will generally be etherificated or esterified. Suitable etherificated starches include, but are not limited to, those which are substituted with ethyl and/or propyl groups. Suitable esterified starches include, but are not limited to, those that are substituted with acetyl, propanoyl and/or butanoyl groups.

In one embodiment of the invention, the starch used to prepare the TPS is corn starch or corn starch acetate having a DS>0.1.

The TPS will generally also comprise one or more polyhydric alcohol plasticisers. Suitable polyhydric alcohols include, but are not limited to glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neo-pentyl glycol, trimethylol propane, pentaerythritol, mannitol, maltitol, sorbitol, xylitol, erythritol and the acetate, ethoxylate, and propoxylate derivatives thereof.

In one embodiment, the TPS comprises glycerol and/or sorbitol plasticisers.

The plasticiser content of the TPS will generally range from about 5 wt. % to about 50 wt. %, for example from about 10 wt. % to about 40 wt. %, or from about 10 wt. % to about 30 wt. %, relative to the combined mass of the starch and plasticiser components.

In the form of physical blend, a composition in accordance with the invention may comprise TPS and/or the constituent components used to manufacture TPS. Where the composition comprises the constituent components to manufacture TPS, it will be appreciated that upon the composition being melt mixed the constituent components of the TPS will be converted in situ into TPS. In other words, it is the intention that any constituent components of TPS in a physical blend will be substantially converted into TPS during melt mixing.

Polyolefin compositions in accordance with the invention will generally comprise the TPS and/or the constituent components thereof in an amount ranging from about 5 wt. % to about 70 wt. %, for example ranging from about 10 wt. % to about 60 wt. %, or from 20 wt. % to about 50 wt. %.

The TPS and/or the constituent components may be provided or used in the form of a masterbatch with polyolefin, amphipathic polymer compatibiliser, and thermoplastic starch. In that case, the TPS and/or the constituent components will be used in an amount ranging from about 30 wt. % to about 80 wt. %, for example ranging from about 40 wt. % to about 80 wt. %, or from 50 wt. % to about 80 wt. %.

Compositions in accordance with the invention also comprise amphipathic polymer compatibiliser. By the expression “amphipathic polymer” is meant a polymer that possesses both hydrophilic and hydrophobic properties. Such properties may, for example, be derived from a polymer having a hydrophobic backbone and hydrophilic moieties covalently attached in a pendant fashion therefrom, a block copolymer structure having one or more hydrophilic blocks and one or more hydrophobic blocks, or from a random or statistical copolymer comprising polymerised residues of both hydrophilic and hydrophobic monomers.

The amphipathic polymer functions as a compatibiliser within the composition. By “compatibiliser” in this context is meant that the amphipathic polymer functions to decrease interfacial tension between, and promote decoupling of, the immiscible polyolefin and TPS phases in a melt mixed form of the composition.

Those skilled in the art will appreciate that (1) the polyolefin will provides for a relatively hydrophobic phase and the TPS will provides for a relatively hydrophilic phase, and (2) polymer compositions that exhibit a multi-phase morphology having high interfacial tension are prone to exhibiting poor physical and mechanical properties. Accordingly, the amphipathic polymer compatibiliser used in accordance with the invention functions in a melt mixed form of the composition to minimise the interfacial tension between the immiscible polyolefin and TPS phases.

Examples of suitable amphipathic polymer compatibilisers include ethylene acrylic acid copolymer (EAA), ethylene vinyl alcohol copolymer (EVOH), ethylene vinyl acetate copolymer (EVA), polyethylene maleic anhydride graft copolymer, poly(ethylene acrylic acid-vinyl alcohol) (EAAVA), poly(acrylic acid) (PAA), poly(methacrylic acid) (PMA), ethylene-methacrylic acid copolymer (EMAA), and poly(acrylamide-acrylic acid) (PAAA).

Polyolefin compositions in accordance with the invention will generally comprise the amphipathic polymer compatibiliser in an amount ranging from about 0.1 wt. % to about 15 wt. %, for example ranging from about 0.5 wt. % to about 10 wt. %, ranging from about 1 wt. % to about 5 wt. %.

The amphipathic polymer compatibiliser may be provided or used in the form of a masterbatch with polyolefin, and thermoplastic starch. In that case, the amphipathic polymer compatibiliser will be used in an amount ranging from about 1 wt. % to about 30 wt. %, for example ranging from about 2 wt. % to about 15 wt. %, or from 5 wt. % to about 15 wt. %.

In one embodiment, the amphipathic polymer compatibiliser is EAA. Those skilled in the art will appreciate that EAA is a copolymer of ethylene and acrylic acid. Generally, the acrylic acid content of the copolymer will range from about 5-20%, for example 8-15%. The EAA used will also generally have a melt index at 190° C./2.16 kg ranging from about 10 g/10 min to about 20 g/10 min.

Compositions in accordance with the invention further comprise iron palmitate. In the composition the iron palmitate can function as a pro-degradant that promotes oxo-degradation of the polyolefin.

Those skilled in the art will appreciate that oxo-degradation of polyolefins occurs through the polyolefin being exposed to oxygen in the presence of heat and/or light. The process is believed to first involve the formation of a radical species on the polyolefin backbone through the polymer being exposed to light and/or heat. This radical species is then believed to react with oxygen and give rise to the formation of hydroperoxide species along the polyolefin backbone. The hydroperoxide species are relatively stable in their own right. However, the presence of a pro-degradant can accelerate decomposition of the hydroperoxide species into oxy radicals. The oxy radicals are very unstable and rapidly promote chain scission of the polyolefin causing a reduction in its molecular weight and consequently a reduction in the physical and mechanical properties of the polymer (i.e. it degrades).

The iron palmitate used may be in the form of ferric palmitate (CAS/20259-32-9) or ferrous palmitate (CAS/36215-91-5).

Iron palmitate is commercially available and may, for example, be prepared by reacting ferric or ferrous chloride with palmitic acid (i.e. hexadecanoic acid).

A particularly convenient source of palmitic acid is from the oil of palm trees (palm oil, palm kernel oil and coconut oil). Accordingly, the iron palmitate may be derived, at least in part, from a renewable resource.

The iron palmitate used may comprise one or more other fatty acid iron salts. For example, it may be that palm oil is used as a feed stock in preparing the iron palmitate. In that case, the manufacture of the iron palmitate may also produce one or more other iron fatty acid salts such as iron oleate.

Where the iron palmitate is present in a composition with one or more other iron fatty acid salts, the iron fatty acid salt mixture can advantageously be used in accordance with the invention.

In one embodiment, the iron palmitate used is manufactured from palm oil.

In one embodiment, the iron palmitate used has an average particle size, as measured by laser light scattering, of less than 1 micron, for example ranging from about 80 nm to about 800 nm, or from about 80 nm to about 600 nm.

The iron palmitate may be provided with such a desired particle size range using a milling process. Providing the iron palmitate with average particle size of at least less than 1 micron has been found to advantageously promote the pro-degradant activity of the compound, assist with dispersion of the compound throughout the melt processed composition, and enhance the ability to control the point in time at which the polyolefin composition begins to catastrophically degrade.

The amount of iron palmitate used/present will vary depending upon the timeframe in which it is desired for the polyolefin composition to begin catastrophically degrading. Generally, polyolefin compositions in accordance with the invention will comprise the iron palmitate in an amount ranging from about 0.01 wt. % to about 4 wt. %, for example ranging from about 0.01 wt. % to about 2 wt. %, ranging from about 0.01 wt. % to about 1 wt. %.

The iron palmitate may be provided or used in the form of a masterbatch with polyolefin. In that case, the iron palmitate will be used/present in an amount ranging from about 0.5 wt. % to about 25 wt. %, for example ranging from about 2 wt. % to about 20 wt. %, or from 5 wt. % to about 15 wt. %.

As used herein, the terms “degradation”, “degrade”, “degraded” or grammatical variations thereof in the context of the polyolefin composition is intended to mean a process whereby the molecular weight of the polyolefin is reduced through a process of oxo-degradation. For convenience, the terms “degradation”, “degrade”, “degraded” or grammatical variations thereof may be used interchangeably herein with the terms “oxo-degradation”, “oxo-degrade”, “oxo-degraded” or grammatical variations thereof.

Those skilled in the art will appreciate that oxo-degradation of polyolefin is a process that occurs continuously in the presence or absence of a pro-degradant. However, it is the degree and rate at which oxo-degradation occurs that is important in the context of the present invention. Use of the iron palmitate as a pro-degradant in accordance with the invention serves to accelerate the degree and rate of oxo-degradation relative to the composition in the absence of the iron palmitate. Given that polyolefin compositions can take hundreds of years to degrade under standard environmental conditions, use of the iron palmitate in accordance with the invention enables degradation of the composition to occur at a desired and practical point in time after manufacture.

A common definition in the art for the period of time in which a polymer product has useful service lifetime is the period in which the tensile strength of the product, as measured according to ISO 527-3 remains at least 50% of the original tensile strength of the product. Alternatively, a polymer product is also referred to in the art as having reached its useful lifetime when its elongation to brake, as measured by ASTM D638; type IV dumbbell is less than 5% and/or the product has a carbonyl index greater than or equal to 0.10, as measured using infrared spectroscopy using the ratio of absorbance peaks at 1465 and 1755.

Accordingly, a composition in accordance with the invention is considered to have catastrophically degraded at a point in time in which a product formed from the composition has (a) a tensile strength, as measured by ISO 527-3, less than 50% of the original tensile strength of the product, and/or (b) an elongation to break, as measured by ASTM D638-type IV dumbbell, of less than 5%, and/or (c) a carbonyl index larger than or equal to 0.10, as measured by infrared spectroscopy using the ratio of absorbance peaks at 1465 and 1755.

Consumer products manufactured using compositions of the invention will therefore be designed and sold with a particular useful lifetime in mind. In other words, such consumer products will generally be sold with a “use by” date. This useful lifetime will largely depend on the amount of iron palmitate in the composition, the type of polyolefin used, and the particle size and distribution of the iron palmitate in that polyolefin.

Those skilled in the art can readily formulate a composition according to the invention to meet the useful lifetime requirements of a given consumer product. For example, a series of trial compositions can be prepared using different concentrations of iron palmitate. The compositions can then be converted into a consumer product that is subjected to accelerated aging (e.g. in an oven at 80° C. for 1 week). The product properties can then be tested and the results extrapolated (if need be) to determine the appropriate concentration of iron palmitate to achieve the desired useful lifetime.

To assist with tailoring a composition in accordance with the invention to provide for a consumer product with a specified useful lifetime, the composition may further comprise one or more oxidation inhibiting agents. Such agents can serve to inhibit oxo-degradation of the polyolefin through various mechanisms such as minimising the formation of carbon centred radicals on the polyolefin backbone (e.g. using UV absorbers), radical scavenging (e.g. using hindered amines and/or phenolic antioxidants), and non-radical decomposition of hydroperoxide species (e.g. using organic phosphites). The agents can therefore be used in conjunction with the iron palmitate to more precisely control the degradation profile of the composition.

Examples of suitable oxidation inhibiting agents include phenolic antioxidants, radical scavenges, organic phosphites, and UV absorbers.

Specific examples of phenolic antioxidants and radical scavengers include Irganox 1010, pentaerythritol tetrakis(3-(3,5-di-tert-butyl-4-hydroxyphenyl)propionate), Irganox 1076, octadecyl 3-(3,5-di-tert-butyl-4-hydroxyphenyl)propionate, and Hostanox 03, ethylene bis[3,3-bis(3-tert-butyl-4-hydroxyphenyl)butyrate].

Specific examples of organic phosphites include

Irgafos 168, Tris(2,4-di-tert-butylphenyl)phosphite, Weston TNPP, Tris(nonylphenyl)phosphite and Weston 705, Nonylphenol-free Phosphite.

Specific examples of UV absorbers include Tinuvin 770, Bis(2,2,6,6-Tetramethyl-4-Piperidinyl) sebacate, and Chimassorb 944, Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]].

In one embodiment, the oxidation inhibiting agent is provided in the form of a co-milled blend with the iron palmitate. In that case, the iron palmitate and oxidation inhibiting agent may be provided as a co-milled blend having average particle size less than 1 micron, for example ranging from about 80 nm to about 800 nm, or from about 80 nm to about 600 nm.

The amount of oxidation inhibiting agent used will vary depending upon the amount of iron palmitate used. Generally, polyolefin compositions in accordance with the invention will comprise the oxidation inhibiting agent in an amount ranging from about 0.01 wt. % to about 4 wt. %, for example ranging from about 0.01 wt. % to about 2 wt. %, ranging from about 0.01 wt. % to about 1 wt. %.

The oxidation inhibiting agent may be provided or used in the form of a masterbatch with the iron palmitate and polyolefin. In that case, the oxidation inhibiting agent will be used in an amount ranging from about 0.5 wt. % to about 25 wt. %, for example ranging from about 2 wt. % to about 20 wt. %, or from 5 wt. % to about 15 wt. %.

Compositions in accordance with the invention may also comprise one or more additives. Such additives may include fillers (e.g. calcium carbonate, talc, clays (e.g. montmorillonite), and titanium dioxide); pigments; anti-static agents; and processing aids (e.g. calcium stearate, steric acid, magnesium stearate, sodium stearate, oxidised polyethylene, oleamide, stearamide and erucamide).

Generally, polyolefin compositions in accordance with the invention will comprise such additives in an amount ranging from about 0.5 wt. % to about 2 wt. %.

Such additives may be included in one or masterbatches used to prepare the polyolefin compositions.

Compositions in accordance with the invention provided in the form of a physical blend may be prepared simply by add-mixing the components in, for example, a high speed mixer. Such a composition may be immediately used, stored and/or transported and then used, to provide for a composition in accordance with the invention in the form of a melt mixed blend.

Compositions in accordance with the invention provided in the form of melt mixed blend can be prepared according to the method of the invention.

According to the method of the invention, one or more compositions comprising one or more of polyolefin, amphipathic polymer compatibiliser, iron palmitate and thermoplastic starch and/or its constituent components are melt mixed together.

Melt mixing may be performed using techniques and equipment well known in the art. Generally, melt mixing is achieved using continuous extrusion equipment, such as single screw extruders, twin screw extruders, other multiple screw extruders or Farrell continuous mixers. Melt mixing is conducted for sufficient time and at a suitable temperature to promote intimate blending between the components of the composition. Those skilled in the art will appreciate that melt mixing is generally performed within a suitable temperature range and that this range will vary depending upon the nature of the polymer(s) being mixed. Generally, the compositions in accordance with the invention will be melt mixed at temperatures ranging from about 150° C. to about 210° C.

Where the composition(s) that is to be melt mixed comprises the constituent components of TPS, the method in accordance with the invention advantageously converts these components during melt mixing into TPS.

The components that are melt mixed in accordance with the method of the invention may be introduced into the melt mixing equipment individually, in combination with one or more of the other components, or at one time in the form of a physical blend of all the components.

In one embodiment, the composition to be melt mixed in accordance with the method of the invention is first physically blended in a high speed mixer. For example, the method may first comprise blending in a high speed mixer in the following order of addition starch, amphipathic polymer compatibiliser, polyolefin, iron palmitate, and one or more polyhydric alcohols such as glycerol and/or sorbitol. Where one or more additives are used in the composition, they may be added directly before the one or more polyhydric alcohols. The physically blended composition may then be melt mixed.

In another embodiment, the method comprises melt mixing a composition comprising polyolefin and iron palmitate with a composition comprising polyolefin, amphipathic polymer compatibiliser, thermoplastic starch and/or its constituent components.

The composition comprising polyolefin and iron palmitate may be a physical blend or a melt mixed blend. In one embodiment it is a melt mixed blend. This composition may further comprise one or more additives as herein described.

The composition comprising polyolefin, amphipathic polymer compatibiliser, thermoplastic starch and/or its constituent components may be a physical blend or a melt mixed blend. In one embodiment it is a melt mixed blend. This composition may further comprise one or more additives as herein described.

The method may therefore comprise melt mixing together (1) a melt mixed composition comprising polyolefin and iron palmitate, and (2) a melt mixed composition comprising polyolefin, amphipathic polymer compatibiliser, and thermoplastic starch.

The melt mixed composition comprising polyolefin and iron palmitate may be prepared by melt mixing a composition comprising polyolefin and iron palmitate in amounts herein described.

The melt mixed composition comprising polyolefin, amphipathic polymer compatibiliser, and thermoplastic starch may be prepared by melt mixing a composition comprising polyolefin, amphipathic polymer compatibiliser, thermoplastic starch and/or its constituent components in amounts herein described.

To prepare a polyolefin composition in accordance with the invention, a composition (A) comprising polyolefin and iron palmitate may be melt mixed with a composition (B) comprising polyolefin, amphipathic polymer compatibiliser, thermoplastic starch and/or its constituent components, in a ratio of about 0.5-5 wt. % (A) to about 95-99.5 wt. % (B).

To prepare a polyolefin composition in accordance with the invention, a composition (A) comprising polyolefin and iron palmitate may be melt mixed with a composition (B) comprising polyolefin, amphipathic polymer compatibiliser, thermoplastic starch and/or its constituent components, and polyolefin (C), in a ratio of about 0.5-5 wt. % (A) to about 10-90 wt. % (B) to about 10-85 wt. % polyolefin (C), or of about 1-3 wt. % (A) to about 30-70 wt. % (B) to about 25-70 wt. % polyolefin (C), or of about 1-2.5 wt. % (A) to about 40-60 wt. % (B) to about 35-65 wt. % polyolefin (C).

Compositions (A) and (B) may be provided in the form of a masterbatch.

Polyolefin compositions in accordance with the invention have been found to exhibit a number of advantageous properties relative to conventional polyolefin compositions. For example, melt mixed compositions in accordance with the invention demonstrate excellent mechanical properties, while at the same time can be tailored such that after a desired period of time a product made from the composition becomes embrittled and fragments into small pieces. Such catastrophic degradation of the polymer composition after a desired period of time can reduce disposal and environmental concerns typically associated with polyolefin compositions.

Furthermore, the compositions may be prepared such that they comprise a relatively high starch content, the effect of which makes the compositions at least in part more susceptible to undergoing biodegradation. Biodegradation of the composition can also advantageously be facilitated by the composition degrading and fragmenting into small pieces. This again alleviates certain disposal and environmental concerns associated with conventional polyolefin compositions.

Still further, compositions in accordance with the invention are prepared using components that may be derived from renewable resources (e.g. the starch and iron palmitate). This too presents an environmental advantage relative to conventional fully petrochemical derived polyolefin compositions.

Without wishing to be limited by theory, it is believed that the improved properties afforded by compositions in accordance with the invention, both in terms of the composition's excellent mechanical properties during its useful lifetime, and also the composition's ability to effectively and efficiently lose such advantageous mechanical properties after a desired period of time, is at least in part due to the unique blend of components that make up the composition together with their ability to combine and form a highly compatibilised blend.

The polyolefin compositions in accordance with the invention are well suited for manufacturing film and molded products where it is desirable for the products to catastrophically degrade after a desired period of time. For example, the compositions are particularly useful in the manufacture of packaging films and agricultural films such as mulch films.

Embodiments of the invention are further described with reference to the following non-limiting examples.

### EXAMPLES

### Example 1

A masterbatch A was produced in a co-rotating twin crew extruder by melt compounding 10 wt. % of iron palmitate supplied by Sage Chemical, Hangzhou, China with 90 wt. % of a low density polyethylene of melt index 2 g/10 min (190° C., 2.16 kg) including common processing aids and lubricants. The melt temperature profile was adjusted to 140/180/180/165/165/160° C., torque<80%, screw speed 300-340 rpm at an output of 185 kg/hr. The melt was extruded through a strand die. The extruded strands were cooled down in a water bath, dried and cut to uniform small pellets.

### Example 2

A masterbatch B was produced from the components listed below in Table 1. The ingredients were first blended in a high speed mixer in the following order of addition: starch, LDPE, VLDPE, EAA, Calcium stearate, stearic acid, glycerol, and sorbitol. The resulting physical blend was then melt processed on a vented twin screw extruder made by Coperion Keya in Nanjing, China, having melt profile 140/170/175/175/165/155° C., torque<80%, screw speed 320-350 rpm, vacuum of −0.05 bar and output of 200 kg/h. The extruded strands were cooled down in a water bath, dried and cut to uniform small pellets.

TABLE 1
Masterbatch B

| Component | Grade and Supplier | Amount | % |
|---|---|---|---|
| Corn Starch | Grade: Food Grade | 50 kg/100.8 kg | 49.6 |
| | Supplier: Shandong Zhucheng Starch Pty Ltd. | | |
| Glycerol | Supplier: Nanjing Soap Factory | 11 kg/100.8 kg | 10.91 |
| | Purity: ≧96% | | |
| Sorbitol | Grade: Sorbitol | 5 kg/100.8 kg | 4.96 |
| | Supplier: Jiangsu Luo'er Gaici Pty Ltd. | | |
| | Purity: ≧70% | | |
| EAA | Ethylene-acrylic acid copolymer | 12 kg/100.8 kg | 11.9 |
| | Grade: Primacor 3440 | | |
| | Supplier: DOW Chemical | | |
| | Acrylic acid content: 8%-15% | | |
| | MFI: 10-20 g/10 mins (190 deg. C., 2.16 kg) | | |
| | Density: 0.932 g/cm3 | | |
| VLLDPE | Grade: Attane 4404 | 10 kg/100.8 kg | 9.92 |
| | Supplier: DOW | | |
| | Density 0.904 g/cc | | |
| | MFI: 4 g/10 mins (190 deg. C., 2.16 kg) | | |
| LDPE | Grade: 1FTB | 12 kg/100.8 kg | 11.9 |
| | Supplier: Beijing Yanshan Pty Ltd. | | |
| | MFI: 7 g/10 mins (190 deg. C., 2.16 kg) | | |
| | Density: 0.92 g/cm3 | | |
| Stearic acid | Supplier: Shanghai factory | 0.5 kg/100.8 kg | 0.49 |
| Calcium | Supplier: Shanghai factory | 0.3 kg/100.8 kg | 0.3 |
| stearate | | | |
| Total | | 100.8 kg | 100% |

A degradable polyolefin composition according to this invention was prepared by dry blending three components, masterbatch A as above added at 2%, masterbatch B as above added at 30% and a blend of polyolefin resins as per Table 2 below. This dry blend was subsequently processed on a 65 mm single screw blown film line to form a film sample of 35 um thickness, Film A.

In order to create a control sample a second film sample, Film B, was produced only from the polyolefin blend as in Table 2 on a 65 mm blown film extruder. The following processing parameters were used for both samples, Film A and B: extrusion temperature profile: 160-180° C., die temperature: 175° C., screw speed: 65 rpm, die diameter: 120 mm and die gap: 1.5 mm.

TABLE 2
Polyolefin Blend

| | | Amount |
|---|---|---|
| Component | Grade and Supplier | % |
| LLDPE | Grade: YLF 1802 | 60 |
| | Supplier: Sinopec Yangzi Petrochemical Co. | |
| | Pty Ltd. | |
| | MFI: 2 g/10 mins (190° C., 2.16 kg) | |
| | Density: 0.918 g/cm3 | |
| LDPE | Grade: 2426H | 40 |
| | Supplier: BASF-YPC | |
| | MFI: 2 g/10 mins (190° C., 2.16 kg) | |
| | Density: 0.92 g/cm3 | |

Both samples, Film A and Film B were then exposed to the same random environmental conditions, such as hot and cold temperatures (5-35° C.), dry and wet conditions and high UV exposure for a period of 6 months.

Table 3 summarises the physical properties of the samples Film A and Film B when tested fresh, after 2 months and after 4 months:

| | | after 3 days | | after 60 days | | after 120 days | |
|---|---|---|---|---|---|---|---|
| | | Film A | Film B | Film A | Film B | Film A | Film B |
| Gauge | μm | 33 | 35 | 33 | 35 | 33 | 35 |
| Tensile Strength—MD | MPa | 22 | 23 | 19 | 21 | na | 19 |
| Tensile Strength—TD | MPa | 15 | 18 | 11 | 19 | na | 13.8 |
| Elongation—MD | % | 201 | 230 | 178 | 202 | na | 153 |
| Elongation—TD | % | 545 | 640 | 412 | 588 | na | 410 |
| Elastic Modulus—MD | N/mm2 | 142 | 155 | 163 | 145 | na | 137 |
| Elastic Modulus—TD | N/mm2 | 181 | 195 | 210 | 187 | na | 179 |

This example shows that after 60 days of environmental exposure the film samples produced according to this invention, Film A, maintain good physical properties comparable to the polyolefin samples, Film B. However, after exposure of 120 days Film A samples show a sharp drop in physical properties to the point that the samples were not strong enough to be tested, whereas the Film B samples were still largely intact and functional.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A polyolefin composition comprising:
polyolefin,
amphipathic polymer compatibiliser,
iron palmitate, and
thermoplastic starch and/or constituent components of the thermoplastic starch.

2. The polyolefin composition according to claim 1 in the form of a melt mixed blend.

3. The polyolefin composition according to claim 1, wherein the iron palmitate is present in an amount ranging from about 0.01 wt. % to about 4 wt. %.

4. The polyolefin composition according to claim 1, wherein the iron palmitate has an average particle size, as measured by laser light scattering, ranging from about 80 nm to about 800 nm.

5. The polyolefin composition according to claim 1, further comprising an oxidation inhibiting agent.

6. The polyolefin composition according to claim 1, wherein the polyolefin comprises very low density polyethylene having a density of less than 0.905 g/cm³.

7. The polyolefin composition according to claim 6, wherein the polyolefin further comprises one or more polyethylene polymers having a density of greater than 0.905 g/cm³.

8. The polyolefin composition according to claim 1, wherein the polyolefin is present in an amount ranging from about 40 wt. % to about 70 wt. %.

9. The polyolefin composition according to claim 1, wherein the thermoplastic starch and/or the constituent components of the thermoplastic starch is present in an amount ranging from about 10 wt. % to about 60 wt. %.

10. The polyolefin composition according to claim 1, wherein the amphipathic polymer compatibiliser is selected from ethylene acrylic acid copolymer, ethylene vinyl alcohol copolymer, ethylene vinyl acetate copolymer, polyethylene maleic anhydride graft copolymer, poly(ethylene acrylic acid-vinyl alcohol), poly(acrylic acid), poly(methacrylic acid), ethylene-methacrylic acid copolymer, poly(acrylamide-acrylic acid), and combinations thereof.

11. The polyolefin composition according to claim 1, wherein the amphipathic polymer compatibiliser is present an amount ranging from about 0.5 wt. % to about 10 wt. %.

12. A method of preparing a polyolefin composition, the method comprising:
melt mixing one or more compositions, each of the compositions comprising one or more of:
(a) polyolefin,
(b) amphipathic polymer compatibiliser,
(c) iron palmitate and
(d) thermoplastic starch and/or constituent components of the thermoplastic starch.

13. The method according to claim 12, wherein the melt mixing comprises melt mixing:
(1) a first one of the compositions comprising the polyolefin and the iron palmitate with
(2) a second one of the compositions comprising the polyolefin, the amphipathic polymer compatibiliser, and the thermoplastic starch and/or the constituent components of the thermoplastic starch.

14. The method according to claim 12, wherein the melt mixing comprises melt mixing:
(1) a first one of the compositions comprising the polyolefin and the iron palmitate with
(2) a second one of the compositions comprising a melt mixed combination of the polyolefin, the amphipathic polymer compatibiliser, and the thermoplastic starch.

15. The method according to claim 12, wherein the melt mixing comprises melt mixing:
a first one of the compositions comprising the polyolefin and the iron palmitate with
(1) a second one of the compositions comprising a melt mixed combination of the polyolefin, the amphipathic polymer compatibiliser, and the thermoplastic starch, and
(2) the polyolefin.

16. The method according to claim 12, wherein the one or more compositions comprise an oxidation inhibiting agent.

17. The method according to claim 16, wherein, before the melt mixing, the oxidation inhibiting agent is co-milled with the iron palmitate.

18. A consumer product comprising a composition according to claim 1.

19. An agricultural film comprising a composition according to claim 1.
